(19) United States
(12) Patent Application Publication
(10) Pub. No.: US 2009/0232136 A1
(43) Pub. Date: Sep. 17, 2009

(54) Method and Apparatus for Scalable Protocol Snooping in a Pon

(75) Inventors: Ralph T. Rodriguez, Santa Rosa, CA (US); Moshe Oron, San Rafael, CA (US); Nurettin Bal, Petaluma, CA (US); Pratima Karamcheti, Leesburg, VA (US)

Correspondence Address: TIPS GROUP;c/o Intellevate LLC, P. O. BOX 52050, Minneapolis, MN, 55402, US

(73) Assignee: Tellabs Petaluma, Inc.

(21) Appl. No.: 12/050,147

(22) Filed: Mar. 17, 2008

(51) Int. Cl. H04L 12/56

(52) U.S. Cl. 370/390; 370/230.1

(57) ABSTRACT

In various example embodiments, a system, method and apparatus are provided for scalable protocol snooping in a PON. In an example embodiment, a method is provided. The method may include receiving a control packet on a network. The method may further include snooping the control packet. The method may also include duplicating the control packet to produce a duplicate control packet. Additionally, the method may include transmitting the control packet and a duplicate control packet to an external network. Moreover, the method may include processing the control packet. In another example embodiment, a method is presented. The method may include receiving a control packet. The method may also include receiving a duplicate control packet on a dedicated port. The method may further include snooping the control packet and the duplicate control packet. Also, the method may include passing the control packet on to an external network. Furthermore, the method may include processing the duplicate control packet.

### BACKGROUND

In general, networks much improve life for people. Networks provide for near instantaneous communication between people and/or machines, facilitating information sharing (e.g. business or social conversations) and transactions (e.g. banking, information sharing) which are a part of the fabric of everyday life. However, maintaining such networks presents challenges.

A communications network which operates in real-world conditions requires a fair amount of control. Controlling the network almost invariably means overhead—additional traffic on the network which does not directly contribute to moving data from point A to point B. Overhead can come into play in terms of control data transported over the network. However, it can also come into play in terms of processing resources devoted to the control data.

Control data can originate from various points on a network, and often originates from client devices. Such data may then need to be processed by an ONT (optical network terminals), OLT (optical line terminal), and other network equipment. Processing by the ONT may take away processor cycles that can otherwise be used to steer packets to and from client equipment. Processing by the OLT can likewise occupy processor cycles that can otherwise be used to steer packets to and from ONTs (and thus client devices). Moreover, control data can require additional ports, thereby further contributing to overhead.

### SUMMARY

In various example embodiments, a system, method and apparatus are provided for scalable protocol snooping in a PON. In an example embodiment, a method is provided. The method may include receiving a control packet on a network. The method may further include snooping the control packet. The method may also include duplicating the control packet to produce a duplicate control packet. Additionally, the method may include transmitting the control packet and a duplicate control packet to an external network. Moreover, the method may include processing the control packet.

In another example embodiment, a method is presented. The method may include receiving a control packet. The method may also include receiving a duplicate control packet on a dedicated port. The method may further include snooping the control packet and the duplicate control packet. Also, the method may include passing the control packet on to an external network. Furthermore, the method may include processing the duplicate control packet.

### BRIEF DESCRIPTION OF THE DRAWINGS

The accompanying illustrations provide illustrations of various example embodiments of the invention, and should be understood as providing examples of the invention, rather than limiting the invention.

FIG. 1 illustrates an example embodiment of a PON (passive optical network).

FIG. 2 illustrates an example embodiment of transmission of control packets on a PON.

FIG. 3 illustrates an example embodiment of a packet such as a control packet for transmission on a PON.

FIG. 4 illustrates an example embodiment of a process of handling and transmitting a control packet from an OLT on a PON.

FIG. 5 illustrates an example embodiment of a process of handling a control packet from an ONT on a PON.

FIG. 6 illustrates an example embodiment of an OLT (optical line terminal) which may implement a process of adding equipment to a PON.

### DETAILED DESCRIPTION

In various example embodiments, a system, method and apparatus are provided for scalable protocol snooping in a PON. The example embodiments described herein provide examples of embodiments of the invention. Thus, the example embodiments should be understood as providing illustrations of the invention rather than limitations on the invention.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” or “example embodiment” means that a particular feature, structure, or characteristic described in connection with the embodiment is included in at least one example embodiment of the invention. The appearances of the phrase “in one embodiment” (and similar phrases) in various places in the specification are not necessarily all referring to the same example embodiment, nor are separate or alternative example embodiments mutually exclusive of other example embodiments.

In an example embodiment, a method is provided. The method may include receiving a control packet on a network. The method may further include snooping the control packet. The method may also include duplicating the control packet to produce a duplicate control packet. Additionally, the method may include transmitting the control packet and a duplicate control packet to an external network. Moreover, the method may include processing the control packet.

In another example embodiment, a method is presented. The method may include receiving a control packet. The method may also include receiving a duplicate control packet on a dedicated port. The method may further include snooping the control packet and the duplicate control packet. Also, the method may include passing the control packet on to an external network. Furthermore, the method may include processing the duplicate control packet.

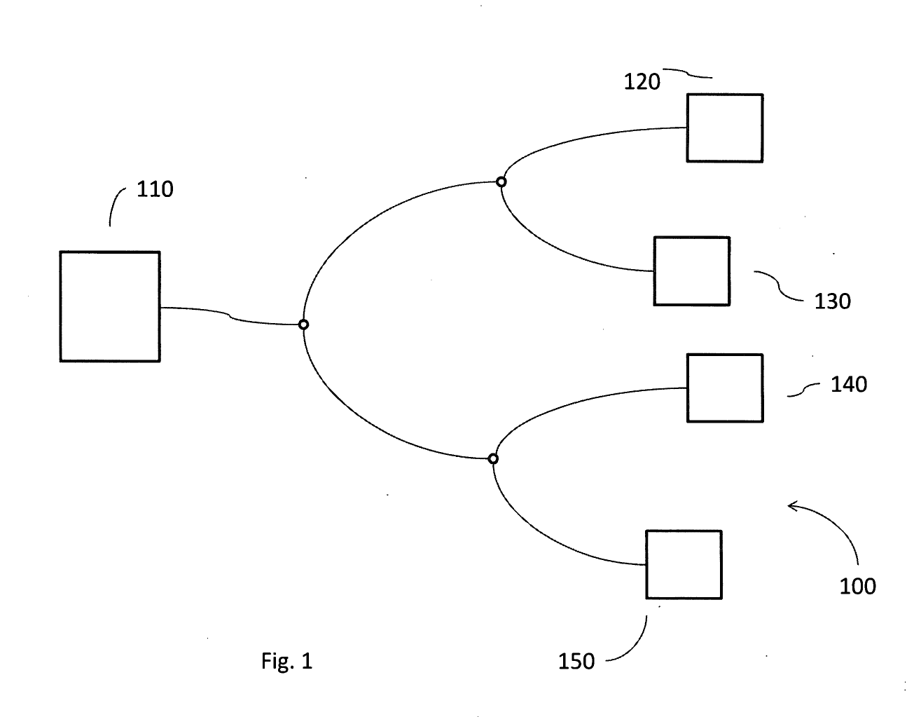

In various example embodiments, the goal of allowing for changing network configurations and topology is met, while allowing for generally steady and effective transmission of real-time data over the network. FIG. 1 illustrates an example embodiment of a PON (passive optical network). PON 100 is illustrated with a central office and a variety of terminal facilities. In particular, an OLT (optical line terminal) 110 can provide functionality at a central office. The OLT 110 represents a device that masters the PON network which steers data to various terminal destinations on the network 100. Coupled to OLT 110 are ONTs (optical network terminals) 120, 130, 140 and 150. These may provide terminal destinations, or may provide a gateway to actual terminal destinations in various example embodiments of such a network. Four ONTs are shown. However, the number of ONTs coupled to a single OLT is not limited to four. For example, 32 or 64 ONTs may be coupled to a single OLT, with each device sending and receiving network traffic along the intervening optical network.

Controlling ONTs and subscriber or client equipment on a PON may affect service to the network. A PON network such as BPON (Broadband PON) or GPON (Gigabit PON) can be a shared media that employs TDMA in the upstream direction. Traffic from different ONTs can be multiplexed by programming each ONT to transmit information designated for specific ports or port IDs, along with segregation based on TDMA grants. However, managing control traffic for ONTs can require resources which would otherwise be devoted to transmission of actual data—the control traffic is overhead.

When Multicast IPTV is deployed across a PON based access network the OLT is expected to snoop a Multicast Group Management protocol (IGMP) in order to efficiently manage Bandwidth within the PON network. The OLT is expected to participate in the Multicast Group Management Protocol by snooping the customer's data stream for the control traffic. Part of snooping is to trap the control packets to the OLT's control plane as well as forward on the control traffic upstream towards the IGMP router. When the service provider uses a 1:1 VLAN model, where each customer is given a unique VLAN tag stack per ONT data port, the upstream IGMP control traffic leaving the OLT is expected to be tagged with the customer's unique VLAN tag stack.

In order to handle control traffic, the OLT can use a variety of options. These options can be related to deep packet inspection, or to internal processing and re-insertion into the data stream, for example. However, both such methods require significant processing overhead, and may delay network traffic. Alternatively, one may insert two copies of a control packet, one targeted to the OLT and a second copy for direct transmission to the external network. In doing so, this allows for any necessary processing to occur without delaying transmission of the packet, and potentially eliminates the need to re-insert packets into the data stream after processing.

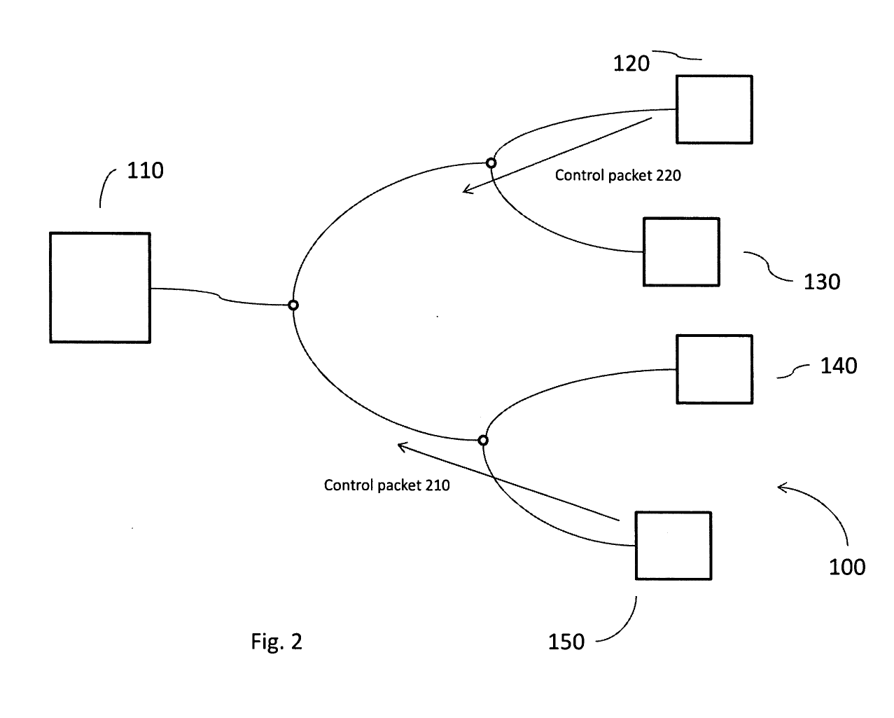

As will be apparent, control packets can be transmitted from any ONT on the PON. FIG. 2 illustrates an example embodiment of transmission of control packets on a PON. Control packet 210 is transmitted from ONT 120 to OLT 110 on PON 100, containing or embodying control information related to a transaction for ONT 120 or a related client device. Similarly, control packet 220 is transmitted from ONT 150 to OLT 110 on PON 100. Control packet 220 would likewise contain or embody control information related to a transaction for ONT 150 or a related client device. Each of control packets 210 and 220 may originate with the associated ONTs (120 and 150, respectively), or may be generated from associated client devices which then send the packets to the ONTs in question.

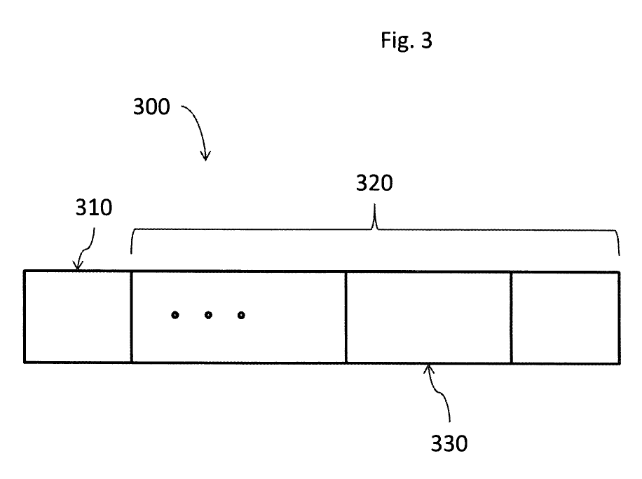

The structure of a packet provides some indication of how this process can occur—how the packet can be handled. FIG. 3 illustrates an example embodiment of a packet such as a control packet for transmission on a PON. Packet 300 includes a header 310 and payload 320. Header 310 includes information used to route the packet within a network (for example within the PON, but also potentially across a wider expanse of network(s)).

Payload 320 contains information to be transmitted. For a data packet, payload 320 generally contains data. For a control packet, payload 320 may contain control information to be processed at one or more intermediate points in the network (or an end terminal), and may also contain filler required to conform the packet 300 to protocol requirements. In particular, a control packet may contain a control information chunk 330 including such information as what intermediate part of the network should process all or part of the packet and how the packet should be processed. This information chunk 330 may be buried in the payload 320, and may be one of several chunks of information about the control packet. As a result, determining how to use the packet may require careful, detailed analysis and processing.

One approach used in some example embodiments involves having the ONT trap the control traffic from the customer's data stream and forward that traffic towards the OLT on a PON traffic identifier (Gem Port Id in the case of GPON, for example) different than that which is carrying the customers' data traffic. To re-insert the control traffic into the customer's data stream, the OLT must apply the appropriate VLAN tag stack and forward the traffic out the network uplink. In this scenario, the management of the per-customer VLAN tag stack then has to be explicitly managed by the OLT. Also, the OLT must provide a way to inject the control traffic upstream.

An alternate approach used in other example embodiments is for the ONT to forward the control traffic on the same PON traffic identifier as the customer traffic. In this case the OLT is required to filter using deep packet inspection for the control traffic. (E.g., the OLT must inspect the buried information chunk 330 in the packet 300 of FIG. 3 in some example embodiments.) The OLT must filter on ALL customer interfaces. The number of customer interfaces is many more than the number of ONTs when MDU ONTs (multiple customers per ONT) are considered. Either of these approaches thus requires considerable overhead and network processing resources.

Thus, another alternative may be desired. In this alternative, used in some example embodiments, the ONT forwards the trapped control traffic to the OLT on a per-ONT unique PON traffic identifier (Gem Port Id in the case of GPON). The ONT replicates trapped control traffic and transparently forwards a copy of the control traffic towards the OLT on the per-customer PON traffic identifier. The OLT filters for all traffic arriving on the per-ONT unique PON traffic identifier which carries the control traffic and traps those to its control plane for processing. Thus, two copies of the packet arrive at the OLT from the ONT. One copy is labeled for the OLT to trap to its control plane. The other copy is labeled for forwarding to the external network, and can be effectively tagged with the appropriate VLAN tag stack.

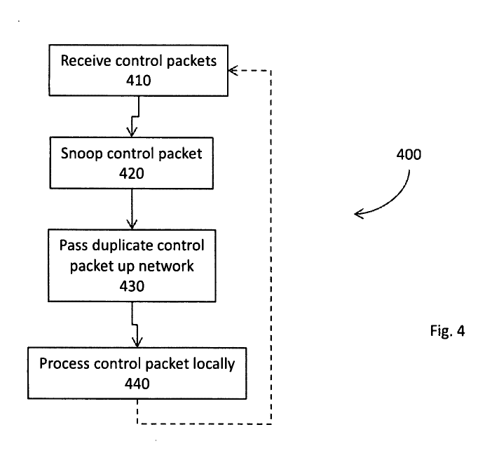

Various processes may be used to implement the alternative described immediately above. FIG. 4 illustrates an example embodiment of a process of handling and transmitting a control packet from an OLT on a PON. Process 400 includes receiving a control packet, snooping the control packet, passing a duplicate control packet through the network and processing the control packet locally. Process 400 and other processes of this document are implemented as a set of modules, which may be process modules or operations, software modules with associated functions or effects, hardware modules designed to fulfill the process operations, or some combination of the various types of modules, for example. The modules of process 400 and other processes described herein may be rearranged, such as in a parallel or serial fashion, and may be reordered, combined, or subdivided in various example embodiments.

Process 400 begins a cycle with receipt of a control packet at module 410. At module 420, the control packet is snooped—it is identified. In this example embodiment, such snooping can involve identifying a packet coming in on a particular port, or otherwise identifying a duplicate packet. The presence of the control packet on the dedicated port will typically identify the packet, simplifying the snooping process.

This can also allow for identification of a corresponding duplicate control packet provided for upstream pass-through purposes. The presence of the packet on the dedicated port can indicate the presence of a related duplicate packet. At module 430, the duplicate packet is passed on to the external network, for processing at other points within the network as needed. The packet in the upstream data need not be identified, and some embodiments simply pass the packet through. At module 440, the control packet as received on the dedicated port is processed locally, allowing for a less time-sensitive approach to processing and allowing for continued operation of the network through the OLT. Thus, the packet in the upstream data need not be snooped—all special treatment can be handled using the packet on the dedicated port. Normal processing of all packets in the upstream data can still occur, without regard to whether a packet is a control packet, for example. This process (400) can be repeated for each control packet (or pair of control packets) received by the OLT as needed.

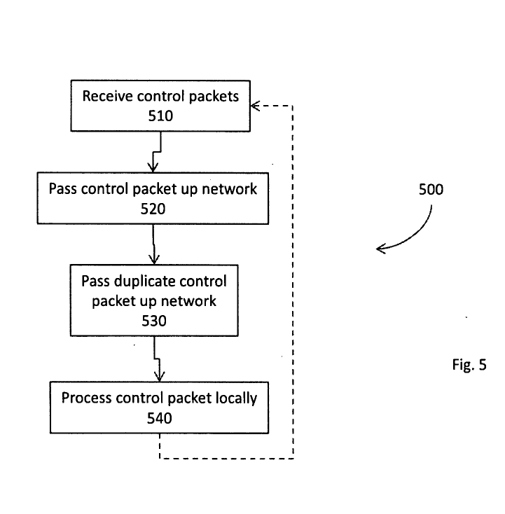

Control packets received at the OLT come from an ONT. FIG. 5 illustrates an example embodiment of a process of handling a control packet from an ONT on a PON. Process 500 includes receiving the control packet, passing the control packet up the network, passing a duplicate control packet up the network, and processing the control packet locally. The duplicate control packet is sent for processing purposes at the OLT, and the original packet is sent for pass-through purposes.

Process 500 begins a cycle with receipt of a control packet at the ONT at module 510. The control packet is passed up the network as regular traffic, on the customer-specified port at module 520. A duplicate packet is also passed up the network on a dedicated control port at module 530. This duplicate packet allows the OLT to receive its own copy of the packet that need not be passed on. At module 540, the control packet is processed locally, allowing for continued operation of the network and for control of the transaction in question. This cycle may similarly be repeated for each control packet. Alternatively, duplicate control packets may be generated at a client/subscriber equipment level, and passed through/processed by the ONT in a similar fashion to passage through and processing by the OLT.

These processes potentially provide a number of advantages. For example, the OLT control plane may not have to explicitly manage the unique per customer VLAN tag stack. Also, the OLT may not have to inject control traffic in the upstream towards the network router. Moreover, to trap the control traffic, the OLT potentially only has to filter on as many PON traffic identifiers (Gem Port Id in the case of GPON) as there are ONTs, rather than having to filter on as many PON traffic identifiers as there are customers. Additionally, the OLT may not have to perform deep packet inspection on the traffic to filter out only the desired control traffic. Each of these advantages is likely to appear to a greater or lesser extent in various example embodiments.

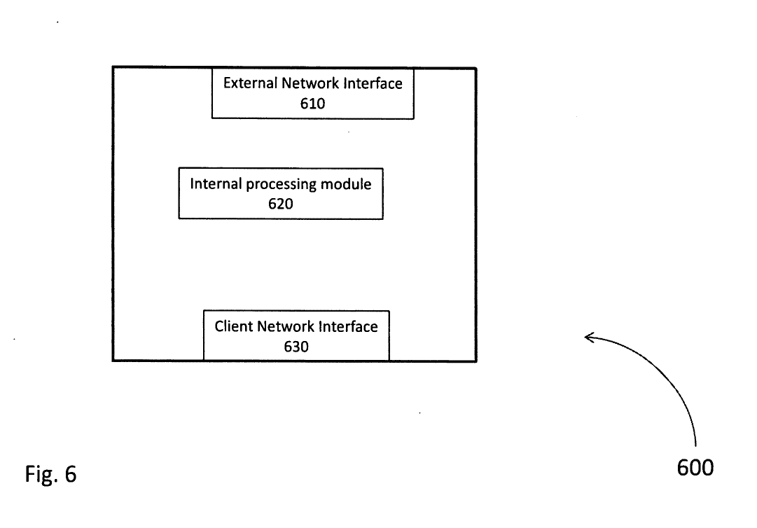

Various different types of equipment may be used in pursuit of implementation of the methods described above. FIG. 6 illustrates an example embodiment of an OLT which may implement a process of adding equipment to a PON. OLT 600 is presented as a generic block diagram to avoid obscuring the present invention. Thus, OLT 600 includes network interfaces (external network interface 610 and PON interface 630) and an internal core 620. Internal core module 620 may take on various forms, potentially centered around a switching fabric or network processor, for example, and may include processors, memory, and other components. Thus, internal core module 620 may process control packets and transmit control packets to the external network, for example. This may be responsive to observed conditions, or to predetermined information.

The OLT 600 is one example of many possible systems which have different architectures. For example, one may have a switching fabric connected with busses to both the network interface module(s) and all PON interface modules. Another bus may directly connect processors and memories (often referred to as a memory bus). The buses are sometimes connected together through bridging or switching components that perform any necessary classification, forwarding or routing between different modules, or network processors that perform protocol processing functions on the transported data. Other components in some example embodiments may include longer term storage, typically of a non-volatile nature, such as FLASH memory or a disk drive. Also, note that an ONT may have a similar architecture, providing for processing of data transmitted to and from client or subscriber equipment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some example embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required operations. The required structure for a variety of these systems is apparent from the description. In addition, the present invention is not described with reference to any particular programming language, and various example embodiments may thus be implemented using a variety of programming languages.

One skilled in the art will appreciate that although specific examples and example embodiments of the system and methods have been described for purposes of illustration, various modifications can be made without deviating from the present invention. For example, example embodiments of the present invention may be applied to many different types of software and operating systems or different types of computers. Moreover, features of one example embodiment may be incorporated into other example embodiments, even where those features are not described together in a single example embodiment within the present document.

What is claimed is:

1. A method, comprising:
receiving a control packet on a network;
snooping the control packet;
duplicating the control packet to produce a duplicate control packet;
transmitting the control packet and a duplicate control packet to an external network;
and
processing the control packet.

2. The method of claim 1, wherein:
the method is implemented at an ONT.

3. The method of claim 2, further comprising:
assigning the duplicate control packet to a dedicated port for control packets.

4. The method of claim 3, further comprising:
shaping traffic flow on the network responsive to the control packet.

5. The method of claim 3, wherein:
the external network is a PON and the control packet and duplicate control packet are transmitted to an OLT.

6. The method of claim 5, further comprising:
receiving the control packet and the duplicate control packet at the OLT;
snooping the control packet and the duplicate control packet at the OLT;
Passing the control packet on to a further external network from the OLT;
and
processing the duplicate control packet at the OLT.

7. A machine readable medium embodying instructions, the instructions causing a processor executing the instructions to perform a method, the method comprising:
receiving a control packet on a network;
snooping the control packet;
duplicating the control packet to produce a duplicate control packet;
transmitting the control packet and a duplicate control packet to an external network;
and
processing the control packet.

8. The machine readable medium of claim 7, wherein the instructions further cause the processor to perform a method which further comprises:
the method is implemented at an ONT.

9. The machine readable medium of claim 7, wherein the instructions further cause the processor to perform a method which further comprises:
assigning the duplicate control packet to a dedicated port for control packets.

10. The machine readable medium of claim 9, wherein the instructions further cause the processor to perform a method which further comprises:
the external network is a PON and the control packet and duplicate control packet are transmitted to an OLT.

11. A method, comprising:
receiving a control packet;
receiving a duplicate control packet on a dedicated port;
snooping the control packet and the duplicate control packet;
passing the control packet on to an external network;
and
processing the duplicate control packet.

12. The method of claim 11, wherein:
the method is implemented at an OLT.

13. The method of claim 12, further comprising:
shaping traffic flow on the network responsive to the control packet.

14. The method of claim 12, wherein:
the network the control packet is received from is a PON.

15. The method of claim 12, wherein:
the control packet originates from a client device and the duplicate control packet originates from an ONT.

16. The method of claim 12, wherein:
the control packet and the duplicate control packet originate from an ONT.

17. The method of claim 12, wherein:
the control packet and the duplicate control packet originate from a client device.

18. A machine readable medium embodying instructions, the instructions causing a processor executing the instructions to perform a method, the method comprising:
receiving a control packet;
receiving a duplicate control packet on a dedicated port;
snooping the control packet and the duplicate control packet;
passing the control packet on to an external network;
and
processing the duplicate control packet.

19. The machine readable medium of claim 18, wherein the instructions further cause the processor to perform a method wherein:
the method is implemented at an OLT.

20. The machine readable medium of claim 18, wherein the instructions further cause the processor to perform a method wherein:
the control packet originates from a client device and the duplicate control packet originates from an ONT.
